(19) United States
(12) Patent Application Publication
(10) Pub. No.: US 2019/0260078 A1
(43) Pub. Date: Aug. 22, 2019

(54) NON-AQUEOUS ELECTROLYTE SECONDARY BATTERY

(71) Applicant: Panasonic Intellectual Property Management Co., Ltd., Osaka-shi, Osaka (JP)

(72) Inventor: Yuanlong Zhong, Osaka (JP)

(73) Assignee: Panasonic Intellectual Property Management Co., Ltd., Osaka-shi, Osaka (JP)

(21) Appl. No.: 16/343,922

(22) PCT Filed: Oct. 16, 2017
(86) PCT No.: PCT/JP2017/037306

§ 371 Date: Apr. 22, 2019

(30) Foreign Application Priority Data
Oct. 24, 2016 (JP) 2016-207868

(51) Int. Cl. H01M 10/0567; H01M 10/0561; H01M 2/02; H01M 10/0587

(52) U.S. Cl. CPC H01M 10/0567; H01M 10/0587; H01M 2/022; H01M 10/0561

(57) ABSTRACT

This non-aqueous electrolyte secondary battery is provided with a positive electrode, a negative electrode, and a non-aqueous electrolyte. The non-aqueous electrolyte includes: a non-aqueous solvent including a fluorine-containing cyclic carbonate; a maleimide compound such as N-ethyl maleimide; and a cyclic carboxylic acid anhydride such as diglycolic acid anhydride.

### TECHNICAL FIELD

The present invention relates to the technology of a non-aqueous electrolyte secondary battery.

### BACKGROUND ART

For example, Patent Literature 1 discloses a non-aqueous electrolyte secondary battery including, a positive electrode, a negative electrode, and an electrolytic solution containing a fluorine-containing cyclic carbonate. Patent Literature 1 states that cyclic characteristics at room temperature are improved by using an electrolytic solution containing a fluorine-containing cyclic carbonate.

### CITATION LIST

### Patent Literature

PATENT LITERATURE 1: Japanese Unexamined Patent Application Publication No. 2013-182807

### SUMMARY

However, in a non-aqueous electrolyte secondary battery using an electrolytic solution containing a fluorine-containing cyclic carbonate, there is a problem of an increase in battery resistance (hereinafter referred to as resistance) under a high temperature environment (for example, 40° C. or more), while the cyclic characteristics at room temperature are improved. An increase in resistance under a high temperature environment may lead to a decrease in capacity recovery rate after storage of the battery under a high temperature environment, or a decrease in capacity during charge/discharge cycles under a high temperature environment.

The object of the present disclosure is to provide a non-aqueous electrolyte secondary battery which can suppress an increase in resistance under a high temperature environment.

The non-aqueous electrolyte secondary battery according to an aspect of the present disclosure includes a positive electrode, a negative electrode, and a non-aqueous electrolyte,

wherein the non-aqueous electrolyte includes a non-aqueous solvent including a fluorine-containing cyclic carbonate, a maleimide compound, and a cyclic carboxylic anhydride represented by the following formula:

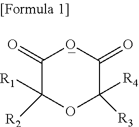

wherein R₁ to R₄ are independently H, an alkyl group, an alkene group, or an aryl group.

According to the non-aqueous electrolyte secondary battery according to an aspect of the present disclosure, an increase in resistance can be suppressed under a high temperature environment.

### DESCRIPTION OF EMBODIMENTS

As described above, in the non-aqueous electrolyte secondary battery using the electrolytic solution including the fluorine-containing cyclic carbonate, there is a problem that resistance under a high temperature environment increases. As a result of intensive investigations by the present inventors, it has been found that an increase in resistance under a high temperature environment can be suppressed by adding a maleimide compound and a cyclic carboxylic anhydride described in detail below to the non-aqueous electrolyte including the fluorine-containing cyclic carbonate. This mechanism is assumed as follows.

In the non-aqueous electrolyte secondary battery comprising the non-aqueous electrolyte including the fluorine-containing cyclic carbonate, at initial charging, a part of the fluorine-containing cyclic carbonate is decomposed on surface of the negative electrode, and a film (Solid Electrolyte Interphase film, hereinafter referred to as SEI film) is formed on the surface of the negative electrode. Usually, the formation of the SEI film derived from the fluorine-containing cyclic carbonate suppresses the decomposition of the non-aqueous electrolyte which occurs in the subsequent charge/discharge process, but the SEI film derived from the fluorine-containing cyclic carbonate lacks thermal stability and thus the SEI film is destroyed under a high temperature environment. As a result, the decomposition of the non-aqueous electrolyte component occurring in the charge/discharge process proceeds, and by-product with electrical insulation is deposited on the negative electrode to increase the resistance of the battery. However, the fluorine-containing cyclic carbonate and the maleimide compound described in detail below are allowed to coexist in the non-aqueous electrolyte so that a maleimide group of a maleimide compound reacts with a carbonate group in the non-aqueous electrolyte to form a film derived from a maleimide group on the negative electrode surface. It is considered that this film has high thermal stability due to the maleimide group, imparting heat resistance to the SEI film derived from the fluorine-containing cyclic carbonate. As a result, the destruction of the SEI film under a high temperature environment is suppressed and thereby further decomposition of the non-aqueous electrolyte is suppressed. In the case of the non-aqueous electrolyte in which the fluorine-containing cyclic carbonate and the maleimide compound coexist, since the SEI film formed on the negative electrode surface is a film with a low ion conductivity, the only coexistence of the fluorine-containing cyclic carbonate and the maleimide compound is insufficient to suppress an increase in resistance of the battery under a high temperature environment. However, the coexistence of a cyclic carboxylic anhydride described in detail below in the non-aqueous electrolyte allows to form an SEI film with a high ion conductivity on the surface of the negative electrode. Thus, it has been considered that according to the non-aqueous electrolyte secondary battery of the present disclosure, the SEI film having a high heat resistance and a high ion conductivity is formed on the negative electrode surface, allowing to suppress the increase in resistance under a high temperature environment.

Hereinafter, an example of the non-aqueous electrolyte secondary battery according to the embodiments will be described.

The non-aqueous electrolyte secondary battery, which is an example of the embodiments, comprises a positive electrode, a negative electrode, and a non-aqueous electrolyte. A separator is preferably provided between the positive electrode and the negative electrode. Specifically, the above battery has a structure in which an exterior body houses the non-aqueous electrolyte and a wound electrode assembly in which the positive electrode and the negative electrode are wound via the separator. Instead of the wound electrode assembly, another form of an electrode assembly may be applied, such as a laminate electrode assembly in which the positive electrode and the negative electrode are laminated via the separator. The form of the non-aqueous electrolyte secondary battery is not particularly limited, and examples thereof include cylindrical, square, coin, button, and laminate tapes.

### Nonaqueous Electrolyte

The non-aqueous electrolyte includes a non-aqueous solvent including the fluorine-containing cyclic carbonate, the maleimide compound, the cyclic carboxylic anhydride, and an electrolyte salt. The non-aqueous electrolyte is not limited to a liquid electrolyte (non-aqueous electrolyte) and may be a solid electrolyte using a gel-like polymer or the like.

The fluorine-containing cyclic carbonate included in the non-aqueous solvent is not particularly limited as long as it is a cyclic carbonate containing at least one fluorine, and examples thereof include monofluoroethylene carbonate (FEC), 1,2-difluoroethylene carbonate, 1,2,3-trifluoropropylene carbonate, 2,3-difluoro-2,3-butylene carbonate, and 1,1,1,4,4,4-hexafluoro-2,3-butylene carbonate. Among these, FEC is preferable from the viewpoint such that the amount of generation of hydrofluoric acid at a high temperature is suppressed.

The content of the fluorine-containing cyclic carbonate is, for example, preferably 0.1% by volume or more and 30% by volume or less, and more preferably 10% by volume or more and 20% by volume or less, based on the total volume of the non-aqueous solvent. When the content of the fluorine-containing cyclic carbonate is less than 0.1% by volume, the amount of formation of the SEI film from the fluorine-containing cyclic carbonate is small, and the cycle characteristics at room temperature may be deteriorated. When the content of the fluorine-containing cyclic carbonate is more than 30% by volume, the amount of formation of the SEI film derived from the fluorine-containing cyclic carbonate increases and the effect of adding the maleimide compound and the cyclic carboxylic anhydride (effect of suppressing increase in resistance under a high temperature environment) may not be sufficiently exhibited.

The non-aqueous solvent may include, for example, a non-fluorine solvent in addition to the fluorine-containing cyclic carbonate. Examples of the non-fluorine solvent include cyclic carbonates, linear carbonates, carboxylic acid esters, cyclic ethers, linear ethers, nitriles such as acetonitrile, amides such as dimethylformamide, and mixed solvents thereof. Examples of the above cyclic carbonates include ethylene carbonate (EC), propylene carbonate (PC), and butylene carbonate.

Examples of the above cyclic carbonates include ethylene carbonate (EC), propylene carbonate (PC), and butylene carbonate. Examples of the above linear carbonate include dimethyl carbonate, methyl ethyl carbonate (EMC), diethyl carbonate, methyl propyl carbonate, ethyl propyl carbonate, and methyl isopropyl carbonate.

Examples of the above carboxylic ester include methyl acetate, ethyl acetate, propyl acetate, methyl propionate (MP), ethyl propionate, and γ-butyrolactone.

Examples of the above cyclic ether include 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methyl furan, 1,8-cineole, and crown ether.

Examples of the above linear ether include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

The maleimide compound included in the non-aqueous electrolyte is not particularly hunted as long as it is a compound having at least one maleirnide group in the molecular structure and examples thereof include a monomaleimide compound, and a bismaleimide compound, and the monomaleimide compound is preferable from the viewpoints such as chemical cost, workability, and solubility.

The monomaleimide compound is represented, for example, by the following formula:

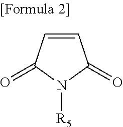

wherein R₅ is a hydrogen group, a monovalent organic group having an aromatic ring or aliphatic hydrocarbon. Examples of the monovalent organic group having an aromatic ring or aliphatic hydrocarbon include an alkyl group, a cycloalkyl group, a monocyclic or polycyclic aryl group.

Specific examples of the monomaleimide compound included in the non-aqueous electrolyte include N-methylmaleimide (the following structural formula (A)), N-ethylmaleimide (the following structural formula (B)), N-propylmaleimide (the following structural formula (C)), N-butylmaleimide (the following structural formula (D)), N-vinylmaleimide (the following structural formula (E)), and N-phenylmaleimide (the following structural formula (F)). Among these, N-ethylmaleimide and N-phenylmaleimide are preferable from the viewpoint such as the effect of suppressing the increase in resistance under a high temperature environment.

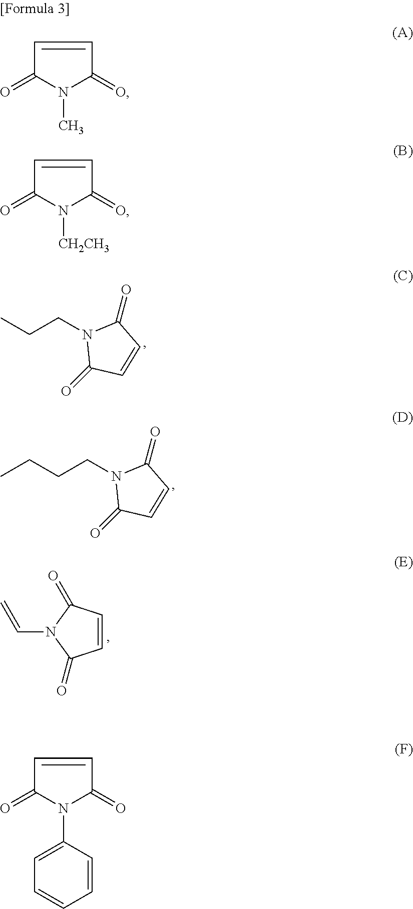

The content of the maleimide compound included in the non-aqueous electrolyte is, for example, preferably the range of 0.1 mass % or more and 1.5 mass % or less, and more preferably the range of 0.1 mass % or more and 0.5 mass % or less, based on the total mass of the non-aqueous electrolyte, from the viewpoint such as the effect of suppressing the increase in resistance under a high temperature environment.

The cyclic carboxylic anhydride included in the non-aqueous electrolyte is represented by the following formula:

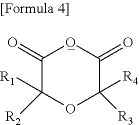

wherein R₁ to R₄ independently represent hydrogen, an alkyl group, an alkene group, or an aryl group. Specific examples of the cyclic carboxylic anhydride included in the non-aqueous electrolyte include diglycolic anhydride, methyldiglycolic anhydride, dimethyldiglycolic anhydride, ethyldiglycolic anhydride, methoxydiglycolic anhydride, ethoxydiglycolic anhydride, vinyldiglycolic anhydride, allyldiglycolic anhydride, divinyldiglycolic anhydride, and divinyldiglycolic anhydride. Among these, diglycolic anhydride is preferable from the viewpoint such as the effect of suppressing the increase in resistance under a high temperature environment.

The content of the cyclic carboxylic anhydride included in the non-aqueous electrolyte is, for example, preferably the range of 0.1 mass % or more and 2.5 mass % or less, more preferably the range of 0.1 mass % or more and 1.0 mass % or less, and furthermore preferably the range of 0.1 mass % or more and 0.5 mass % or less, based on the total mass of the non-aqueous electrolyte, from the viewpoint such as the effect of suppressing the increase in resistance under a high temperature environment.

An electrolyte salt included in the non-aqueous electrolyte is preferably a lithium salt. As the lithium salt, those used as a supporting salt in the conventional non-aqueous electrolyte secondary battery can be widely used. Specific examples thereof include LiPF₆, LiAsF₆, LiClO₄, LiCF₃SO₃, LiN(FSO₂)₂, LiN(C₁F₂ₗ₊₁SO₂)(CₘF₂ₘ₊₁SO₂)(1 and m are integers of 0 or more), LiC(CₚF₂ₚ₊₁SO₂)(C_{q}F_{2q+1}SO₂)(CᵣF₂ᵣ₊₁SO₂) (p, q, and r are integers of 1 or more), Li[B(C₂O₄)₂] (bis(oxalate) lithium borate (LiBOB)), Li[B(C₂O₄)F₂], Li[P(C₂O₄)F₄], and Li[P(C₂O₄)₂]. These lithium salts may he used singly or in combination of two or more.

### Positive Electrode

The positive electrode is composed of, for example, a positive electrode current collector such as, a metal foil and a positive electrode active material layer formed on the positive electrode current collector. The positive electrode current collector can use a metal foil that is stable in the potential range of the positive electrode such as aluminum, a film in which the metal is disposed on the surface layer, and the like. The positive electrode can be prepared by, for example, coating a positive electrode mixture slurry including the positive electrode active material, a binder, and the like on the positive electrode current collector, drying the coating film, and rolling the film to form the positive electrode active material layer on the positive electrode current collector.

Examples of the positive electrode active material include a lithium transition metal complex oxide, and specific examples thereof include lithium cobaltate, lithium manganate, lithium nickelate, lithium nickel manganese complex oxide, and lithium nickel cobalt complex oxide. To these lithium transition metal composite oxides, Al, Ti, Zr, Nb, B, W, Mg, Mo or the like may be added.

As a conductive agent, carbon powders such as carbon black, acetylene black, ketjen black, and graphite may be used singly or in combination of two or more.

Examples of the binder include a fluorine polymer and a rubber polymer. Examples of the fluorine polymer include polretrafluoroethylene (PTFE), polyvinylidene fluoride (PVdF), or modified products thereof and examples of the rubber polymer include an ethylene-propylene-isoprene copolymer and an ethylene-propylene-butadiene copolymer, and these polymers may be used singly or in combination of two or more.

### Negative Electrode

The negative electrode comprises, for example, a negative electrode current collector, such as the metal foil, and a negative electrode active material layer formed on the negative electrode current collector. The negative electrode current collector can use a metal foil that is stable in the potential range of the negative electrode such as copper, a film in which the metal is disposed on the surface layer, and the like. In addition to the negative electrode active material, the negative electrode active material layer preferably includes a thickener and the binder. The negative electrode can be prepared by, for example, coating a negative electrode mixture shiny in which the negative electrode active material, the thickener, and the binder are dispersed in water at a predetermined weight ratio on the negative electrode current collector, drying the coating film, and rolling the film to form the negative electrode active material layer on the negative electrode current collector.

Examples of the negative electrode active material include a carbon material and a non-carbon material capable of absorbing and releasing lithium ions. Examples of the carbon material include graphite, hardly graphitizable carbon easily graphitizable carbon, fibrous carbon, coke, and carbon black. As the non-carbon material, silicon, tin, and alloys or oxides mainly including them can be used.

As the binder, PTFE or the like may be used as in the case of the positive electrode, and a styrene-butadiene copolymer (SBR) or a modified product thereof may be used. As the thickener, carboxymethyl cellulose (CMC) or the like may be used.

### Separator

As the separator, for example, a porous sheet or the like having ion permeability and insulating property is used. Specific examples of the porous sheet include microporous thin films woven fabrics, nonwoven fabrics, and the like. As the material of the separator, olefinic resins such as polyethylene and polypropylene, cellulose, and the like are suitable. The separator may be a laminate body having a cellulose fiber layer and a thermoplastic resin fiber layer such as an olefin resin. A multilayer separator including a polyethylene layer and a polypropylene layer may be used, and a separator coated with a material such as an aramid resin or a ceramic on the surface of the separator may be used.

### EXAMPLES

Hereinafter, the present disclose will be described in more detail with reference to Examples, but the present disclose is not limited to the following Examples.

### Example 1

### Preparation of Positive Electrode

As the positive electrode active material, the lithium composite oxide represented by the general formula. LiNi_{0.8}Co_{0.15}Al_{0.05}O₂ was used. 100 mass % of the positive electrode active material, 1 mass % of acetylene black as the conductive material, and 0.9 mass % of polyvinylidene fluoride as the binder were mixed and N-methyl-2-pyrrolidone (NMP) was added thereto to prepare a positive electrode mixture slurry. The positive electrode mixture slurry was applied to both surfaces of a 15 μm thick positive electrode current collector made of aluminum by a doctor blade method, and the coating film was subjected to rolling to form a 70 μm thick positive electrode active material layer on both surfaces of the positive electrode current collector. This was used as the positive electrode.

### Preparation of Negative Electrode

100 mass % of graphite as the negative electrode active material and 1 mass % of the styrene-butadiene copolymer (SBR) as the binder were mixed and water was added thereto to prepare a negative electrode mixture slurry. The negative electrode mixture shiny was applied to both surfaces of a 10 μm thick negative electrode current collector made of copper by the doctor blade method, and the coating film was subjected to rolling to form a 100 μm thick negative electrode active material layer on both surfaces of the negative electrode current collector. This was used as the negative electrode.

### Preparation of Electrolytic Solution

Fluorinated ethylene carbonate (FEC), ethyl methyl carbonate (EMC), and dimethyl carbonate (DMC) were mixed at a volume ratio of 15:45:40, LiPF₆ was dissolved in the mixed solvent so as to be 1.3 mol/L, and 0.5 mass % of N-ethylmaleimide (NEM) and 0.5 mass % of diglycolic anhydride (DGA) were dissolved therein to prepare an electrolytic solution.

### Preparation of Cylindrical Battery

Each of the positive electrode and the negative electrode was cut into a predetermined size, attached with an electrode tab, and wound via the separator to prepare a wound electrode assembly. With insulating plates disposed above and below the electrode assembly, the electrode assembly is housed in a Ni-plated steel exterior can with a diameter of 18 mm and a height of 65 mm; the negative electrode tab was welded to the inner bottom of the battery exterior can; and the positive electrode tab was welded to the bottom plate of the sealing body. The above electrolytic solution was injected from the opening of the exterior can, and the exterior can was sealed with the sealing body to prepare a cylindrical battery.

### Example 2

In the preparation of the electrolytic solution, an electrolytic solution as prepared in the same manner as in Example 1, except that 0.5 mass % of N-ethylmaleimide (NEM) and 1.0 mass % of diglycolic anhydride (PGA) were dissolved to prepare the electrolytic solution. A cylindrical battery was prepared in the same manner as Example 1 using the electrolytic solution.

### Example 3

In the preparation of the electrolytic solution, an electrolytic solution was prepared in the same manner as in Example 1, except that 0.5 mass % of N-ethylmaleimide (NEM) and 1.5 mass % of diglycolic anhydride (DGA) were dissolved to prepare the electrolytic solution. A cylindrical battery was prepared in the same manner as Example 1 using the electrolytic solution.

### Example 4

In the preparation of the electrolytic solution, an electrolytic solution was prepared in the same manner as in Example 1, except that 1.0 mass % of N-ethylmalemide (NEM) and 0.5 mass % of diglycolic anhydride (DGA) were dissolved to prepare the electrolytic solution. A cylindrical battery was prepared in the same manner as Example 1 using the electrolytic solution.

### Example 5

In the preparation of the electrolytic solution, an electrolytic solution was prepared in the same manner as in Example 1, except that 1.5 mass % of N-ethylmaleimide (NEM) and 0.5 mass % of diglycolic anhydride (DGA) were dissolved to prepare the electrolytic solution. A cylindrical battery was prepared in the same manner as Example 1 using the electrolytic solution.

### Example 6

In the preparation of the electrolyte solution, an electrolyte solution was prepared in the same manner as in Example 1, except that N-phenylmaleimide (NPM) was used instead of N-ethylmaleimide (NEM). A cylindrical battery was prepared in the same manner as Example 1 using the electrolytic solution.

### Comparative Example 1

In the preparation of the electrolytic solution, an electrolytic solution was prepared in the same manner as in Example 1, except that N-ethylmaleimide (NEM) and diglycolic anhydride (DG) were not added. A cylindrical battery was prepared in the same manner as Example 1 using the electrolytic solution.

### Comparative Example 2

In the preparation of the electrolytic solution, an electrolytic solution was prepared in the same manner as in Example 1, except that diglycolic anhydride (DGA) was not added. A cylindrical battery was prepared in the same manner as Example 1 using the electrolytic solution.

### Comparative Example 3

In the preparation of the electrolytic solution, an electrolytic solution was prepared in the same manner as in Example 1, except that N-phenylmaleimide (NPM) was used instead of N-ethylmaleimide (NEM) and diglycolic anhydride (DGA) was not added. A cylindrical battery was prepared in the same manner as Example 1 using the electrolytic solution.

### Comparative Example 4

In the preparation of the electrolytic solution, an electrolytic solution was prepared in the same manner as in Example 1, except that N-ethyhnaleimide (NEM) was not added. A cylindrical battery was prepared in the same manner as Example 1 using the electrolytic solution.

### High Temperature Storage Test

### Resistance

Each battery of Examples and Comparative Examples was charged with a constant current of 0.3 C until the battery voltage was 4.1 V and discharged for 10 seconds with a. constant current of 0.5 C. The resistance was determined from the voltage change before and after the discharge and the discharge current value. This evaluation of the resistance was performed before the battery was kept under a high temperature environment at 40° C. (the first day) and after the battery was kept for nine months, and the rate of increase resistance shown in the following formula was determined. The results are shown in Table 1.

Rate of increase in resistance=(Resistance value for 9 months/Resistance value for 1st day)×100

### High Temperature Cycle Test

### Resistance

Each battery of Examples and Comparative Examples was charged with a constant current of 0.5 C until the battery voltage was 4.1V and discharged for 30 seconds with a constant current of 0.5 C under a high temperature environment at 45′C. The resistance was determined from the voltage change before and after the discharge and the discharge current value. This resistance evaluation was performed at the 1st cycle and 300th cycle of the above cycle test, and the rate of increase in resistance shown in the following formula was determined. The results are shown in Table 1.

Rate of increase in resistance=(resistance value at the 300th cycle/resistance value at the 1st cycle)×100

TABLE 1

| | | Rate of | Rate of |
|---|---|---|---|
| | | increase in | increase in |
| | | resistance | resistance |
| | | in high | in high |
| | | temperature | temperature |
| | | storage test | cycle test |
| | Additive substance | (%) | (%) |
| | (mass %) | 9th month | 300th cycle |
| Comparative | Without | 39 | 16 |
| Example 1 | | | |
| Comparative | NEM(0.5) | 23 | 17 |
| Example 2 | | | |
| Comparative | NPM(0.5) | 39 | 15 |
| Example 3 | | | |
| Comparative | DGA(0.5) | 28 | 15 |
| Example 4 | | | |
| Example 1 | NEM(0.5) + DGA(0.5) | 13 | 4 |
| Example 2 | NEM(0.5) + DGA(1.0) | 20 | 13 |
| Example 3 | NEM(0.5) + DGA(1.5) | 17 | 17 |
| Example 4 | NEM(1.0) + DGA(0.5) | 18 | 10 |
| Example 5 | NEM(1.5) + DGA(0.5) | 18 | 12 |
| Example 6 | NPM(0.5) + DGA(0.5) | 21 | 14 |

NEM: N-ethylmaleimide
NPM: N-phenylmaleimide
DGA: diglycolic anhydride

In the batteries of Examples 1 to 6, the rate of increase in resistance in the high temperature storage test was smaller than the battery in Comparative Example 1 which did not include the above maleimide compound and the above cyclic carboxylic anhydride in the electrolytic solution; the batteries in Comparative Examples 2 and 3 which included the above maleimide compound but did not include the above cyclic carboxylic anhydride; and the battery in Comparative Example 4 which included the above cyclic carboxylic anhydride but did not include the above maleimide compound. In the high temperature cycle test, the batteries in Examples also tended to have a smaller rate of increase in resistance than the batteries in Comparative Examples. These results indicate that an increase in resistance under a high temperature environment can be suppressed by adding both the above cyclic carboxylic anhydride and the above maleimide compound into the electrolytic solution.

From comparison among the rates of increase in resistance in Examples 1, 2, and 3 or comparison among the rates of increase in resistance in Examples 1, 4, and 5, the rate of increase in resistance tends to increase as the amount of the maleimide compound and the cyclic carboxylic anhydride added increases, and the amount of the maleimide compound and the cyclic carboxylic anhydride added is more preferably 0.5 mass % or less based on the total mass of the non-aqueous electrolyte.

1. A non-aqueous electrolyte secondary battery comprising a positive electrode, a negative electrode, and a non aqueous electrolyte
wherein the non-aqueous electrolyte includes:
a non-aqueous solvent including a fluorine-containing cyclic carbonate;
a maleimide compound; and
a cyclic carboxylic anhydride represented by the following formula: 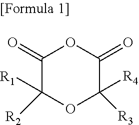
wherein R₁ to R₄ independently represent H, an alkyl group, an alkene group, or an aryl group.

2. The non-aqueous electrolyte secondary battery according to claim 1, wherein a content of the fluorine-containing cyclic carbonate is 0.1% by volume or more and 30% by volume or less based on the total volume of the non-aqueous solvent.

3. The non-aqueous electrolyte secondary battery according to claim 1, wherein a content of the maleimide compound is 0.1 mass % or more and 1.5 mass % or less based on the total mass of the non-aqueous electrolyte.

4. The non-aqueous electrolyte secondary battery according to claim 1, wherein the content of the cyclic carboxylic anhydride is 0.1 mass % or more and 2.5 mass % or less based on the total mass of the non-aqueous electrolyte.

5. The non-aqueous electrolyte secondary battery according to claim 1, wherein the maleimide compound includes at least any one of N-methylmaleimide, N-ethylmaleimide, N-propylmaleimide, N-butylmaleimide, N-vinylmaleimide, or N-phenylmleimide.

6. The non-aqueous electrolyte secondary battery according to claim 1, wherein the cyclic carboxylic anhydride includes at least any one of diglycolic anhydride, methyldiglycolic anhydride, dimethyldiglycolic anhydride, ethyldiglycolic anhydride, methoxydiglycolic anhydride, ethoxydiglycolic anhydride, vinyldiglycolic anhydride, allyldiglycolic anhydride, divinyldiglycolic anhydride, or divinyldiglycolic anhydride.
